(19) United States
(12) Patent Application Publication
(10) Pub. No.: US 2019/0236448 A1
(43) Pub. Date: Aug. 1, 2019

(54) SYSTEM FOR PREDICTING AND MITIGATING ORGANIZATION DISRUPTION BASED ON FILE ACCESS PATTERNS

(71) Applicant: Jungle Disk, L.L.C., San Antonio, TX (US)

(72) Inventor: Bret Piatt, San Antonio, TX (US)

(21) Appl. No.: 15/885,777

(22) Filed: Jan. 31, 2018

(51) Int. Cl. G06N 3/08; G06F 17/30

(52) U.S. Cl. CPC G06N 3/08; G06F 17/30091

(57) ABSTRACT

Various systems and methods are described of tracking event data, backup, data retention and system continuity policy data, and correlating those to business rhythms to infer a business value for each system, set of files, and processes. Based upon the evaluation of the key systems and files, an expected value of various files and processes can be inferred, as well as the expected value of changes to the files and processes. System backup, retention, and system continuity changes can be tuned to maximize business continuity and reduce the price and/or cost of risk.

### BACKGROUND OF THE INVENTION

### a. Field of the invention

The present disclosure generally relates to systems for predicting and protecting against the effects of file loss or unavailability due to natural disaster, human e or software intended to damage or disable computers and computer systems.

### b. Background Art

The increased importance of computer-based systems for every business function has resulted in a corresponding increase in systems designed to protect against and mitigate the effects of computer system malfunction or loss. On an individual file basis, this can be accomplished through versioning software. For individual user files or particular computers, this can take the form of file backup and restoration systems. For whole systems, there are “disaster recovery” and “business continuity” systems that allow for continued operation even in the event of major disruption or system attack.

One drawback of these systems, however, is that there is little evaluation of the value and importance of various files to continuing operations. There may be policies that direct certain systems to be backed up more often, or to have higher availability architectures used so as to minimize disruption, but those policies are based upon human action and understanding which in many cases may not be sufficient to capture actual files and processes of importance or in some cases, may overprotect various files and systems that are not actually as critical to business operations, wasting money and increasing the complexity of backup systems and the money associated with saving and managing backups of files. Further, prior attempts to categorize and classify files as “important” or “not important” were stymied by the increasing complexity of modern systems, making them less effective and intractable for human evaluation

With recent advances in machine learning allowing for pattern recognition over massive datasets, it is possible to create a continually-updated model of the importance of individual files, people, applications, and processes to ongoing business operations by observing of the changes in data structure and file accesses over time. This model can then be used to tune backup and disaster recovery efforts, making them more efficient. Further, the correlation of particular files, people, applications and processes to actual business continuity and value allows the creation of a financial model for different types of interruptions and the pricing of different types of risk.

### BRIEF SUMMARY OF THE INVENTION

In various embodiments, a protecting system identifies key systems, files, and processes, and correlates those to business rhythms to infer a business value for each system, set of files, and processes. Based upon the evaluation of the key systems and files, one embodiment changes the allocation of backup and disaster recovery resources to focus on higher imputed value resources.

In one embodiment, an estimate of business disruption risk is quantified into a dollar amount that is charged as part of an insurance policy or provided as part of a guarantee by a service provider associated with the risk of disruption.

In one embodiment, the configuration or pricing of a service, guarantee, or insurance policy is differentially modified based upon changes in protection processes that increase or decrease the chance of organization disruption.

In one embodiment, changes in business operations over time are automatically identified based upon observation of system dynamics and protection processes or guarantees are updated according to the model.

### BRIEF DESCRIPTION OF THE DRAWINGS

FIG. 1 is a schematic view illustrating a cloud backup and protection system according to various embodiments.

FIG. 2a is a schematic view illustrating an information processing system as used in various embodiments

FIG. 2b is a schematic view illustrating an agent subsystem for monitoring and protecting an information processing system as used in various embodiments.

FIG. 2c is a schematic view illustrating an agentless subsystem for monitoring and protecting an information processing system as used in various embodiments.

FIG. 3a is a representation of the client view of a filesystem tree as used in various embodiments.

FIG. 3b illustrates the change in a filesystem of an information processing system over a series of discrete snapshots in time as used in various embodiments.

FIG. 4 shows a set of metadata recorded about be files in an information processing system according to one embodiment.

FIG. 5 shows a file access frequency graph as used in various embodiments.

FIG. 6a shows a method of grouping periodic data according to various embodiments.

FIG. 6b is a graph showing a Fourier transform of a periodic trace.

FIG. 6c shows a set of periodic measurements grouped by frequency and intensity.

FIG. 6d shows a chromagram.

FIG. 6e shows a sorted chromagram.

FIG. 7 shows a convolutional neural network used in various embodiments.

### DETAILED DESCRIPTION OF THE INVENTION

In the following description, various embodiments of the claimed subject matter are described with reference to the drawings. In the following description, numerous specific details are set forth in order to provide a thorough understanding of the underlying innovations. Nevertheless, the claimed subject matter may be practiced without various specific details. In other instances, well-known structures and devices are shown in block diagram form in order to facilitate describing the subject innovation. Various reference numbers are used to highlight particular elements of the system, but those elements are included for context, reference or explanatory purposes except when included in the claim.

As utilized herein, terms “component,” “system,” “datastore,” “cloud,” “client,” “server,” “node,” and the like refer to portions of the system as implemented in one or more embodiments, either through hardware, software in execution on hardware, and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The existence of various undiscussed subelements and subcomponents should be interpreted broadly, encompassing the range of systems known in the art. For example, a “client” may be discussed in terms of a computer having the identified functions and subcomponents (such as a keyboard or display), but known alternatives (such as a touchscreen) should be understood to be contemplated unless expressly disclaimed.

More generally, descriptions of “exemplary” embodiments should not necessarily to be construed as preferred or advantageous over other aspects or designs. Rather, use of the word exemplary is intended to disclose concepts in a concrete fashion.

Further, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

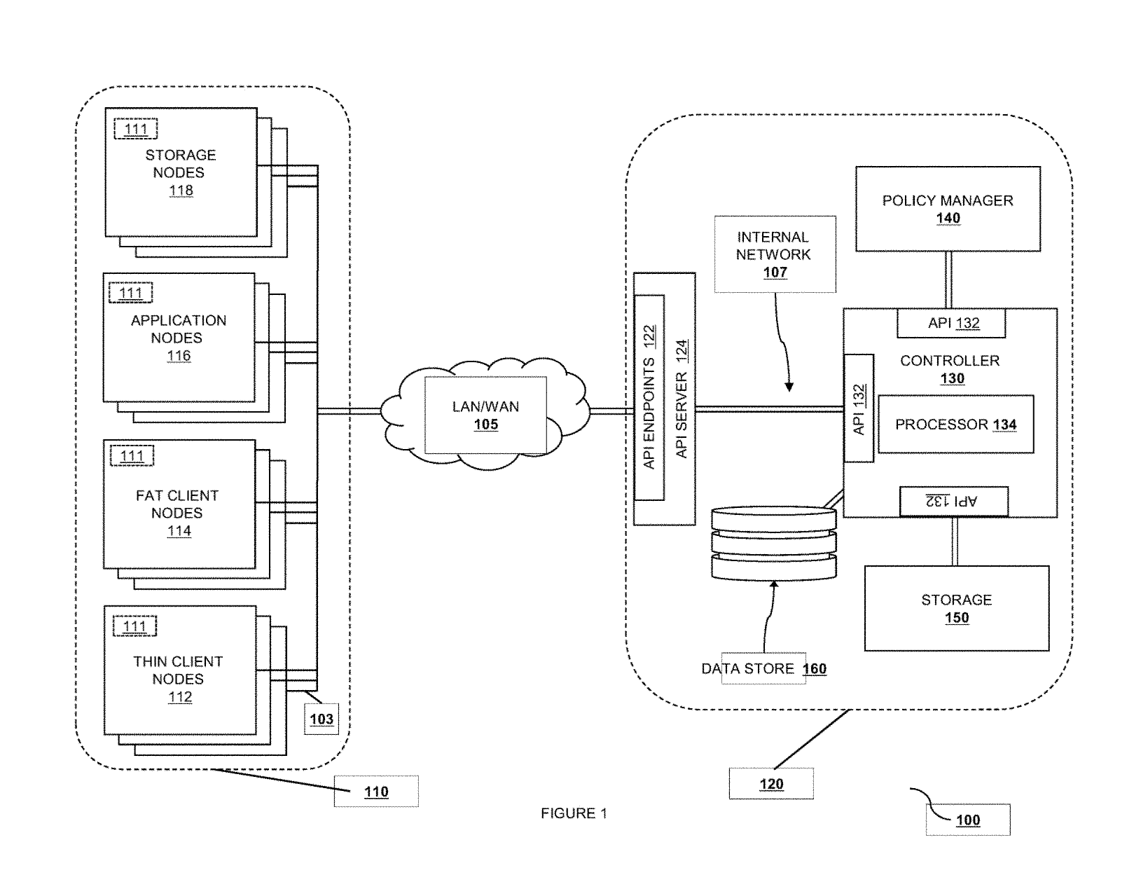

FIG. 1 shows a cloud backup and protection system 100 usable by various embodiments. The cloud backup system 100 primarily consists of two grouped systems: the protected systems 110 and the protecting system 120, each connected to each other via LAN/WAN 105. In many embodiments, the protected systems 110 will correspond to the systems controlled by a client or customer, and the protecting system corresponds to the systems controlled by a computer protection services provider. Although these two systems are each drawn inside of a particular “box” that shows their logical grouping, there is no implied physical grouping. The protected systems may be in one or more physical locations, the protecting systems may be in one or more physical locations, and the protecting and protected systems may be co-located or not. There are network connections 103 shown connecting the protected systems with each other, both those connections are exemplary only; the only necessary connection is to the protecting system 120 via LAN/WAN 105.

The protected systems includes a variety of information processing systems grouped into “thin client” nodes 112, “fat client” nodes 114, “application” nodes 116, and “storage” nodes 118. Each of the information processing systems 112, 114, 116, and 118 is an electronic device capable of processing, executing or otherwise handling information. Examples of information processing systems include a server computer, a personal computer (e.g., a desktop computer or a portable computer such as, for example, a laptop computer), a handheld computer, and/or a variety of other information handling systems known in the art. The distinctions between the different types of nodes has to do with the manner in which they store, access, or create data. The thin client nodes 112 are designed primarily for creating, viewing, and managing data that will ultimately have its canonical representation maintained in some other system. Thin client nodes 112 may have a local storage, but the primary data storage is located in another system, either located within the protected organization (such as on a storage node 118) or in another organization, such as within the protecting organization 120 or within some third organization not shown in the diagram. Fat client nodes 114 have a local storage that is used to store canonical representations of data. An application node 116 hosts one or more programs or data ingestion points so that it participates in the creation of new data, and a storage node 118 includes storage services that are provided to other nodes for use. Either an application node 116 or a storage node 118 may or may not be the location of a canonical representation of a particular piece of data. Note that the categories of nodes discussed above (“fat client,” “thin client,” “application,” and “storage”) are not exclusive, and that a particular node may be a fat client in certain circumstances or with reference to certain data, a thin client in other circumstances and for other data, and likewise an application or storage node in certain circumstances or for certain data. These different roles may take place serially in time or contemporaneously. Certain embodiments may also benefit from optional agents 111, which may be associated with any type of node and which are command processors for the protection system 120. In addition, the term “node” is not necessarily limited to physical machines only, and may include containers or virtual machines running on a common set of underlying hardware by means of a hypervisor or container management system, where the hypervisor can itself be a “node” and the managed virtual machines or containers are also optionally “nodes.”

The protecting system 120 has a number of associated subcomponents. At the network ingestion point there is an API endpoint 122 with a corresponding API server 124. Although this has been drawn in the singular, there may be more than one API endpoint 122 on each API server 124, and there may be more than one API server 124. These API servers 124 may be combined to provide additional robustness, availability, data isolation, customer isolation, or for other business or technical reasons. The API server 124 may perform appropriate error checking, authorization, or transformation on any information or call that comes in via API endpoint 122 prior to passing the call or data to controller 130. Controller 130 is the primary processor for the protecting system. Controller 130 is implemented either as an information processing system, a process, subprocess, container, virtual machine, integrated circuit, or any combination of the above. In various embodiments, controller 130 interacts with other components via internal APIs 132, and it may include a dedicated processor or subprocessor 134. The controller 130 implements the “protecting” code and monitors the state of the protected systems, taking action when necessary. The processes and methods described herein are implemented by or on controller 130, in conjunction with other special-purpose elements of the protecting system. In various embodiments these can include a policy manager 140, a storage 150, or a data store 160. The policy manager 140 is a processing element including specific-purpose code and/or hardware enabling it to efficiently model business or security policies in a logical form and evaluate compliance with those policies on an ongoing basis. The storage 150 can be an internal component, a single system, or multiple systems providing a method for safely storing and retrieving arbitrary bit sequences. These bit sequences can be internally represented as objects, as a bit/byte array, or as a log-structured, or tree-structured filesystem. Various storages may support multiple access methods to facilitate ease of use. The data store 160 is a structured data storage, such that arbitrary data can be stored, but there are restrictions on the form or the content of the data to allow superior searchability, relationality, or programmability. In various embodiments, the data store 160 can be a SQL or NoSQL database.

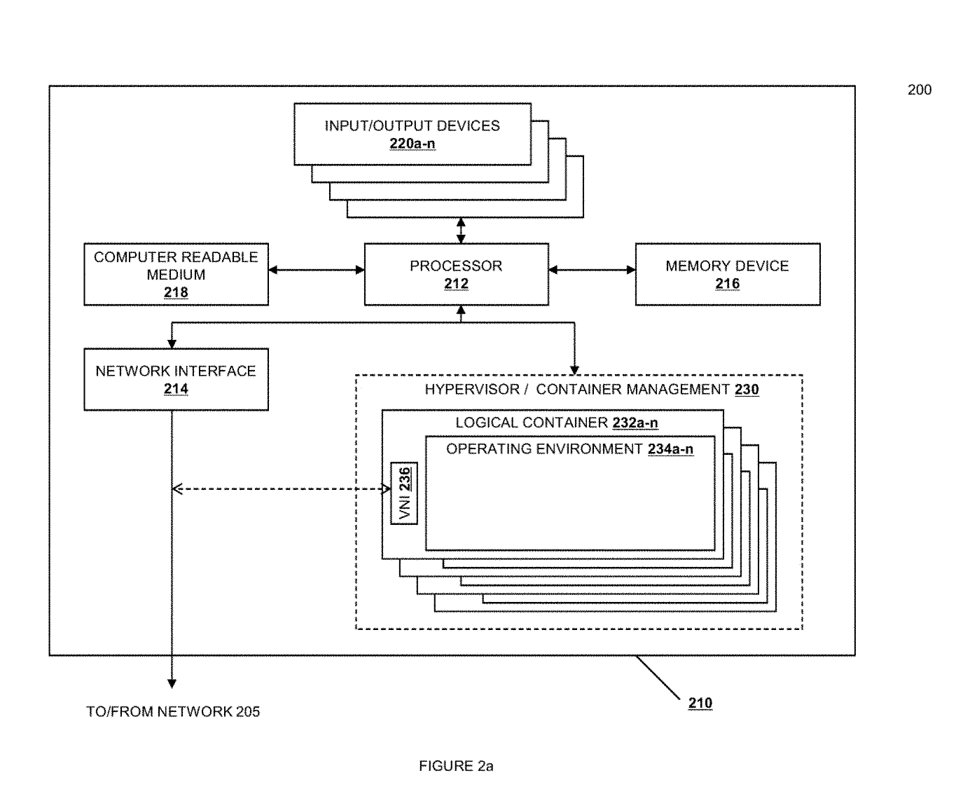

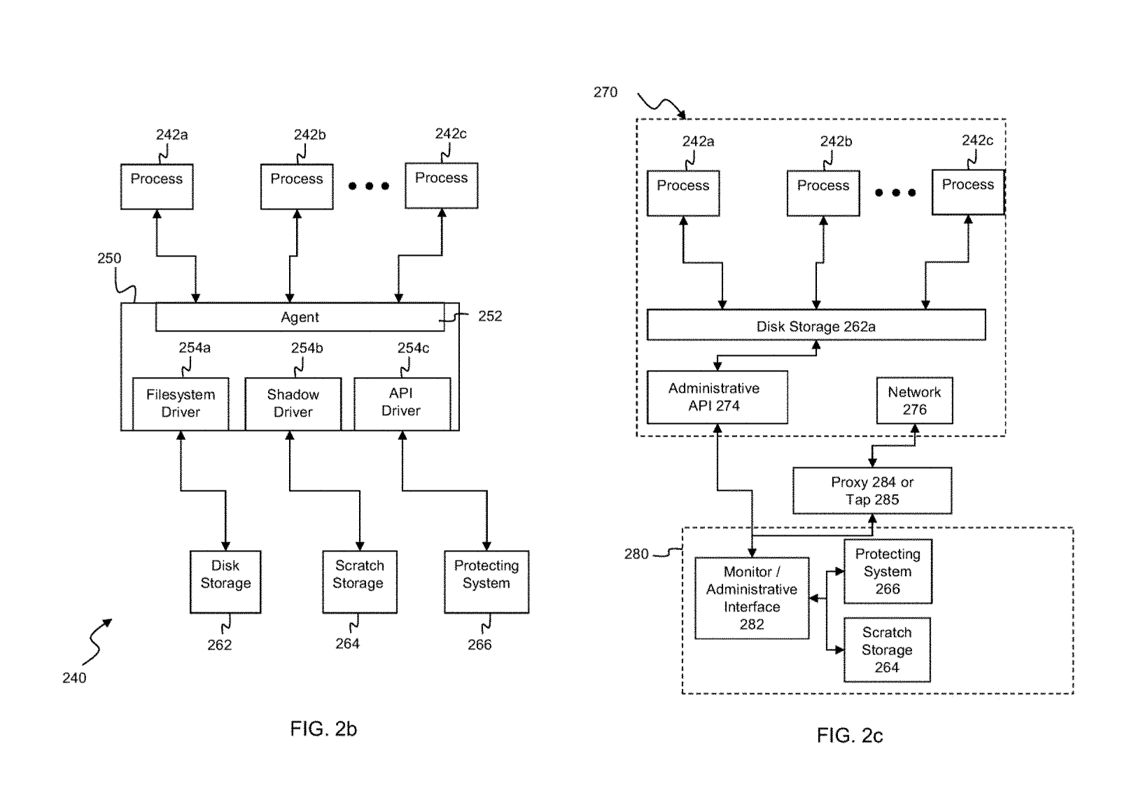

FIG. 2a shows the details of an information processing system 210 that is representative of, one of, or a portion of, any information processing system as described above. The information processing system 210 may include any or all of the following: (a) a processor 212 for executing and, otherwise processing instructions, (b) one or more network interfaces 214 (e.g., circuitry, antenna systems, or similar) for communicating between the processor 212 and other devices, those other devices possibly located across the network 205; (c) a memory device 216 (e.g., FLASH memory, a random access memory (RAM) device or a read-only memory (ROM) device for storing information (e.g., instructions executed by processor 212 and data operated upon by processor 212 in response to such instructions)). In some embodiments, the information processing system 210 may also include a separate computer-readable medium 218 operably coupled to the processor 212 for storing information and instructions as described further below. In one or more embodiments, the information processing system 210 may also include a hypervisor or container management system 230, the hypervisor/manager further including a number of logical containers 232a-n (either virtual machine or process-based), each with an associated operating environment 234a-n and virtual network interface VNI 236a-n.

In one embodiment, the protecting system uses an agent (such as agent 111 discussed relative to FIG. 1) to observe and record changes, with those changes being recorded either locally or by the protecting system. 120 in the storage 150 or the data store 160. In another embodiment, changes to files requested by the client node, especially those with canonical representations in locations other than the monitored node, are captured as network traffic either on network 103 or based on an agent or interface associated with the storage system holding the canonical representation. Generally, there are a number of methods of capturing and recording user data already known in the art, such as those associated with backup, monitoring, or versioning systems. These various capturing and recording systems for automatically capturing user data and changes made to user data can be included as an equivalent to the agent 111 and capturing functionality associated with the protecting system.

FIGS. 2b and 2c show two embodiments the interface between the protecting system and a protecting system. FIG. 2b is an implementation of an agent system as with agent 111) used in various embodiments and FIG. 2c is an implementation of an agentless system as used in various embodiments.

Turning to FIG. 2b, the agent subsystem is shown at reference 240. In an embodiment that uses an agent present on the information processing system, the agent 252 is interposed as a filter or driver into the file-system driver stack 250. In one embodiment, this is a kernel extension interposed between the kernel and filesystem interface. In another embodiment, it is a filesystem driver that actually “back-ends” to existing filesystem drivers. In a third embodiment, there is no kernel or filesystem driver, but the agent is a user-space process that listens to kernel 110 events through an API such as the inotify API. Another embodiment may simply be a process that “sweeps” the disk for new changes on a regular basis. Each of these embodiments has advantages and drawbacks. Implementations that interface with the kernel are more likely to be resistant to change by malware, but may also have higher overhead. Embodiments in user space may be easier to deploy.

Assuming an embodiment that uses a filter driver, all file-oriented API requests being made by various processes 242a-c are intercepted by the agent filter 252. Each process reading and writing is viewable by the agent, and a “reputation” score can be maintained for each process on the basis of its effects on the user's data. For each API request, the ordinary course of action would be to send it to one or more backend drivers simultaneously. A trusted change can be sent directly through the filesystem driver 254a to the disk storage 262. Changes that have some probability of user data damage are sent through shadow driver 254b to scratch storage 264, which provides a temporary holding location for changes to the underlying system. Changes in the scratch storage can be either committed by sending them to the disk storage 262, or they can be sent to the protecting system at 266, or both. This allows the permeability of changes to be modified on a per-file, dynamically changing basis. It also allows changes to user data to be segregated by process, which can assist in the identification and isolation of malware, even though the malware process itself is not being sampled or trapped. It also allows the protecting system to keep a log of the changes to the file on a near-real-time basis, and keep either all changes or those deemed significant.

In an implementation that does not intercept all file-oriented API requests being made by the processes 242a-c, the agent process instead follows closely behind each change. In one embodiment, this is done by sampling from lsof (“list open files”) or a similar utility and listening for filesystem change events. Processes can be associated with changes to individual files through the combination of information provided and each change can then be sent to the protecting system as in the previously discussed filesystem filter driver embodiment. Scratch files can be kept in a separate location either on or off the protected system. Although the data permeability on the client system may be higher, the permeability of harmful data changes into the storage areas managed by the protecting system can still be kept low.

FIG. 2c shows one implementation of an “agentless” system. A node of the protected system is identified at reference 270. Because there is no resident agent on the system, local filesystem changes by processes 242a-c are committed directly to the local disk storage 262.

Because the protecting system does not have an agent resident on the protected node 270, there are a collection of remote monitor processes, shown generally as the dotted box at reference 280. In this embodiment, there are two primary methods of interacting with the system. The first is the administrative API 274, which is built in to the operating environment on protected node 270. This administrative API allows the starting and stopping of processes, the copying of files within the system and over the network connection 276, and other administrative actions. The monitor/administrative interface 282 interacts remotely with the administrative API to read file changes and make copies of files to the scratch storage 264 or to send information to the protecting system 266 to implement the protections as described further herein. The second primary method of interacting with the protected node 270 is by monitoring external network traffic via proxy 284. Interactions with file storages and APIs are intercepted and provided to the monitor 282. In this case, the proxy acts similarly to the filesystem filter driver as described relative to FIG. 2b, but for remotely stored user data.

An alternative agentless implementation uses network tap 285 instead of proxy 284. A network tap is a system that monitors events on a local network and in order to analyzing the network or the communication patterns between entities on the network. In one embodiment, the tap itself is a dedicated hardware device, which provides a way to access the data flowing across a computer network. The network tap typically has at least three ports: An A port, a B port, and a monitor port. A tap inserted between A and B passes all traffic through unimpeded in real time, but also copies that same data to its monitor port, enabling a third party to listen. Network taps are commonly used for network intrusion detection systems, VoIP recording, network probes, RMON probes, packet sniffers, and other monitoring and collection devices and software that require access to a network segment. Use of the tap for these same purposes can be used to provide enhanced security for the protected system 270. Taps are used in security applications because they are non-obtrusive, are not detectable on the network (having no physical or logical address), can deal with full-duplex and non-shared networks, and will usually pass through or bypass traffic even if the tap stops working or loses power. In a second embodiment, the tap may be implemented as a virtual interface associated with the operating system on either the protected or protecting systems. The virtual interface copies packets to both the intended receiver as well as to the listener (tap) interface.

Many implementations can use a mixture of agented and agentless monitors, or both systems can be used simultaneously. For example, an agented system may use a proxy 284 to detect changes to remotely stored user data, while still using a filter driver to intercept and manage locally stored data changes. The exact needs are dependent upon the embodiment and the needs of the protected system. Certain types of protected nodes, such as thin client nodes 112, may be better managed via agentless approaches, whereas fat client nodes 114 or application nodes may be better protected via an agent. In one embodiment, storage nodes 118 may use an agent for the storage nodes' own files, whereas a proxy is used to intercept changes to user files that are being stored on the storage node 118 and monitored for protection.

Various embodiments of a system for identifying key people, files, and systems associated with business processes and mitigating business risk will be discussed in the context of a protected and protecting system as disclosed above.

One function of the protecting system 120 is the maintenance generally of “backups”—that is, time-ordered copies of the system files allowing recovery of both individual files and complete systems. The representation of these backups within the storage 150 is not essential to any embodiment, but various embodiments do leverage the client protected system's view of the storage. In most cases, the client's view of the system is as one or more filesystem trees.

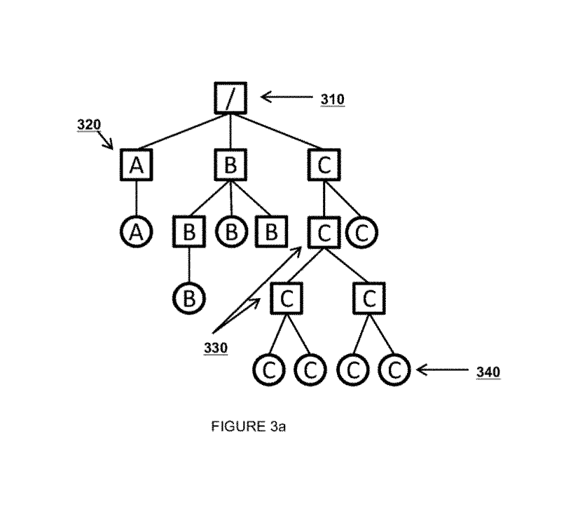

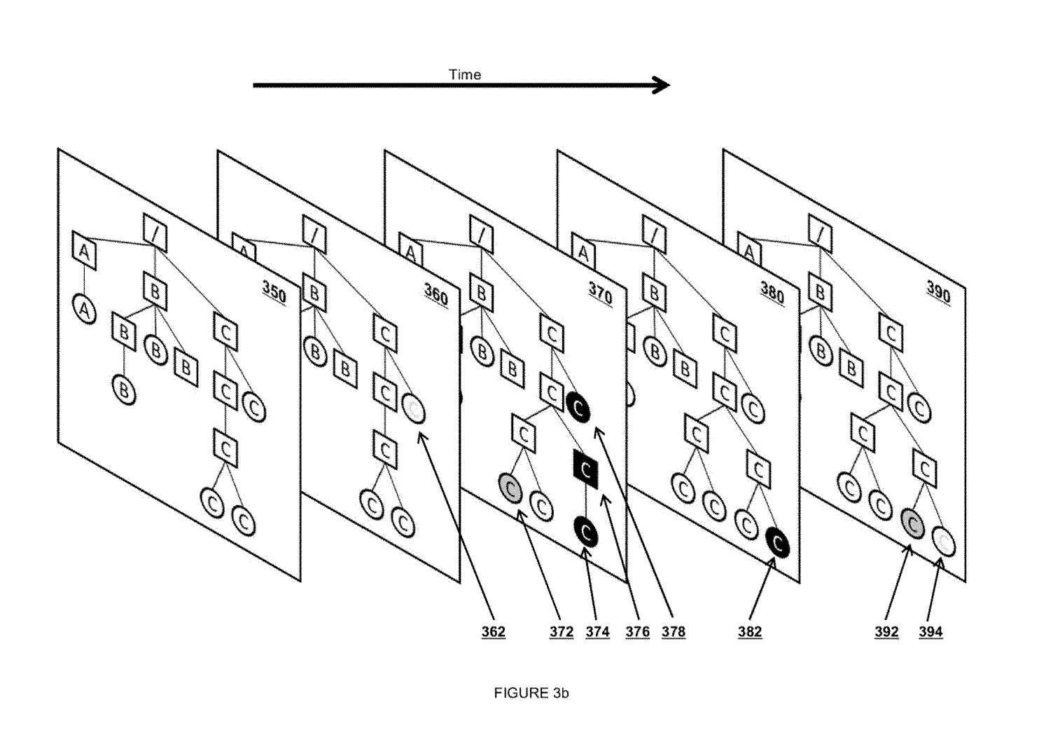

FIG. 3a shows a logical representation of a filesystem tree, with root 310, user directory 320, user subdirectories 330, and user files 340. FIG. 3b shows how the filesystem can change over time, with each representation 350, 360, 370, 380 and 390 showing a different consistent snapshot of the filesystem tree. From snapshot 350 to 360, the user file 362 is deleted. From snapshot 360 to 370, the user file 372 is changed in content, the user directory 376 is created as well as user file 374 and user file 378 is created in the same location as the previous user file 362. Snapshot 380 shows the creation of new user file 382, and snapshot 390 show the deletion of the new file at 394 and a change in the contents of the file at 392. The protecting system records the changes to the file system, including making whole-filesystem-tree snapshots or by making sequential ordered copies of individual files and just recording the tree locations as metadata. One typical use of this capability is for backups of user or system data, but, as described in the present disclosure, the protecting system 120 uses both the client logical view of the filesystem—the client data—as well as information regarding the patterns of change (such as the changes from snapshot to snapshot in FIG. 3b), and the change in the nature of client data (as shown at reference 372 in FIG. 3b) to identify changes that may have an effect on business operations.

One measure of the system is the allowed data permeability, that is, the ability for changes in the data to move through and be recorded and made permanent (high permeability) versus having all changes be temporary only (low permeability). The goal of the system is to have high permeability for requested and user-directed changes, and low permeability for deleterious data changes, if changes to user data can be characterized relative to their utility, then high-utility changes can be committed and low-utility changes blocked, regardless of whether they are malicious or not. For example, the truncation of a file may be the result of user error rather than malware, but characterizing the change as having low utility suggests that the permeability to that change should be low. In various embodiments, this is implemented by keeping a number of different versions of the file in snapshots or “shadow” filesystems by the protecting system, corresponding to one of the filesystem snapshots as described relative to FIG. 3b. In another embodiment this is implemented using a log-oriented data structure, so that earlier versions of files and filesystems are maintained until a rewriting/vacuum procedure occurs. From the perspective of the user of the system, each change is committed and the state of the filesystem is as expected from the last few changes that have occurred. But from the perspective of the protecting system, each change is held and evaluated before it is committed, and different types of changes will be committed further and other changes will be transparently redirected to a temporary space that will have no effect on the long-term data repository. In addition, various embodiments also take file-based or system-based snapshots not only due to the passage of time (as in the prior art), but due to observed changes in the user data that may be indicative of malware action or user error.

Moving temporarily to the problem of risk, it there are various ways to measure the risk and exposure associated with actual or potential customers. Those in charge of underwriting evaluate statistical models associating the characteristics of the client (or potential client) with historical claims to decide how much coverage a client should receive, how much they should pay for it, or whether even to accept the risk and provide insurance or some other type of guarantee. Putting aside the investment value of money, the difference in profits between two otherwise identical companies relates to the ability to accurately model and price the risk associated with a particular client or group of clients so that the amount paid on claims does not exceed in aggregate the amount collected.

Underwriting in general models various types of insurable parties as being subject to a random events, with the expectation that the cost associated with a particular risk will may be high in a particular case but will be low enough over the population of insured parties to spread to protect the company against excessive claims. Each organization providing insurance or a similar type of guarantee has a set of underwriting guidelines informed by statistical tables to determine whether or not the company should accept the risk. These statistical tables measure the cost and frequency of different types of claims based upon the categorization of the insured entity according to a number of different criteria, each of which has been shown to have an effect on the frequency or severity of insurable events. Based upon an evaluation of the possible cost of an event and an estimation of the probability of the event, the underwriter decides what kind of guarantees to provide and at what price.

Thus, while there exist in the prior art various statistical models of risk, there are two significant difficulties associated with applying different models of risk to business activities, particularly those associated complex systems such as the protected systems described herein as well as the interactions that may lead to different types of losses. First, the systems are too dissimilar to create effective cross-organization models of risk, and second, the possible perturbing factors associated with the risk are so numerous as to be essentially unknowable or susceptible to human analysis. This results in mispriced risk models that either do not effectively mitigate the risk associated with different types of loss events, or are too expensive for the coverage received, or both.

In contrast to human-oriented forms of risk analysis, however, whole-system risk can be evaluated for an individual organization by correlating data access and change patterns with business flows and processes. The economic value of those processes can be evaluated, and regression analysis used to isolate and estimate the additive or subtractive value of each type of change, thus allowing the creation of a dynamic risk pricing model that is tailored to an individual organization.

From the perspective of a whole-system model, each individual protected node and the files and processes within that protected node are each possible “features” for each type of malware has a distinctive effect on user data. The different types of monitored changes are described, and then the model that correlates those with business value. Different types of changes will be described, as well as how those observed changes are interpretable by a model as features that can predict disruption.

The first type of change is a change in the contents of a file, as is shown relative to reference 372. This change in the contents of the file may be the result of either user-directed action, error, or attack (e.g., due to internal action by a rogue employee or malware). A second type of change in the filesystem looks like the movement and/or deletion of files as shown from snapshot 350, through 360 at reference 362 (file is removed) and then a new file is written in place (reference 376 in snapshot 370). A third type of change looks like the changes in user files 374, to 382, to 392 and 394 in snapshots 370-390. The existing user file 374 is read and a new output is created as new file 382 in snapshot 380, and then the new file is renamed to replace the original file, which appears as a change in content at reference 392 and the removal of the file at reference 394 (both in snapshot 390).

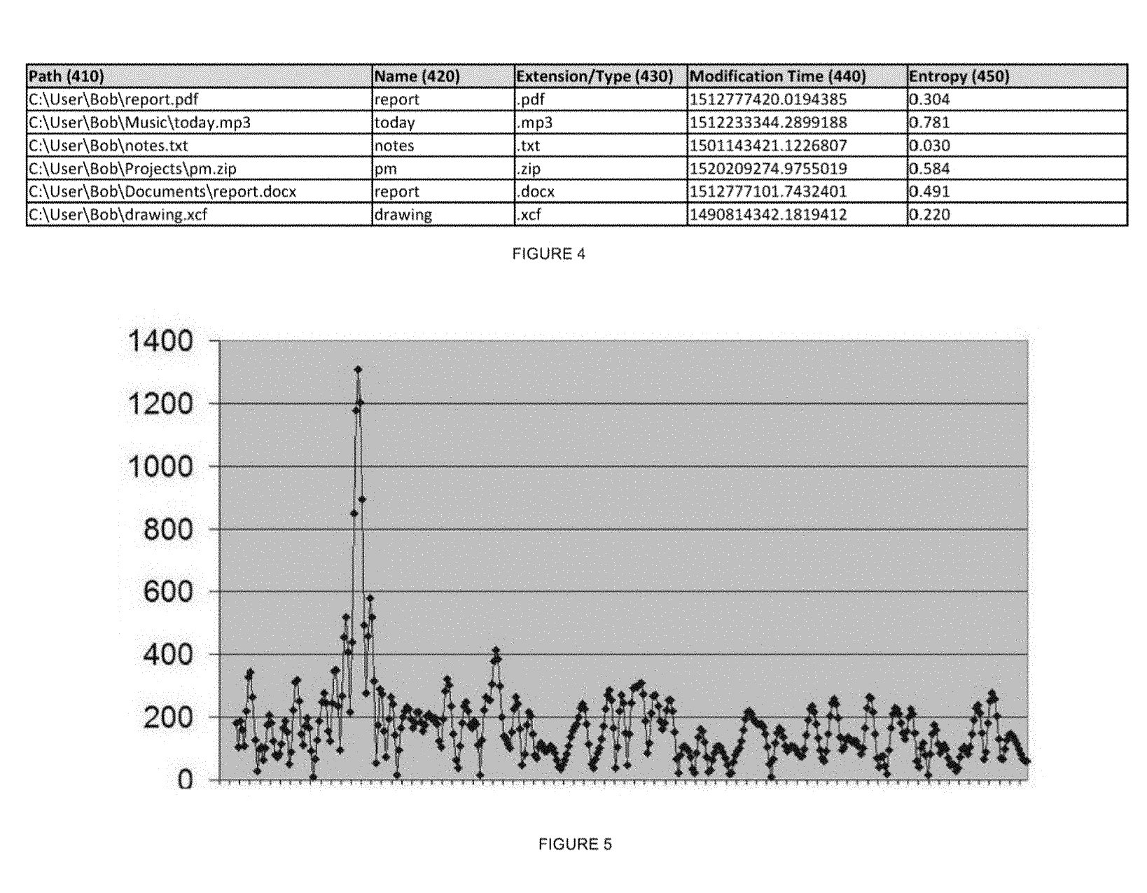

FIG. 4 shows a different aspect of user data captured by the system—the metadata associated with a particular file. Included in the typical metadata tracked by protecting systems are the path to user files 410, the names of user files 420, the extension (or the associated file type) of a file 430, and creation and/or modification times 440. In one embodiment of the protecting system, the system also records the entropy of the associated file 450.

Looking at different aspects of the user data captured by the system, the name, type, and content of a file can be important. Capturing the name and extension is straightforward. Capturing the file type requires evaluation of the file contents as well as the file extension. The type of data stored in a file can be approximated using “magic numbers.” These signatures describe the order and position of specific byte values unique to a file type, not simply the header information. In one embodiment, the filetype is determined by the magic number of the file, followed by the type signature, followed by the extension. By comparing the file type before and after the change in the file, possibly deleterious changes in the file can be identified. While not every change in a file type is significant, a change in type—especially without an accompanying change in extension—tends to suggest a risk.

Measuring the content of the file can also be important, but each organization is going to be unique in what they consider to be “important” data. Other organizations may be concerned about any attempt to read and interpret the underlying business data. Therefore, the entropy of the file—a measure of the information content—can be evaluated instead and used as an input to the process.

The entropy associated with the file's values in sequence equal the negative logarithm of the probability mass function for the value. This can considered in terms of either uncertainty (i.e., the probability of change from one bit/byte to the next) or in terms of possible information content. The amount of information conveyed by each changed becomes a random variable whose expected value is the information entropy. Human-intelligible data tends to have lower entropy. Certain types of data, such as encrypted or compressed data, have been processed to increase their information content and are accordingly high in entropy. The entropy of a file can be defined as the discrete random variable X with possible values {0,1} and probability mass function P(X) as by a fair coin flip:

H(X)=E[I(X)]=E[−ln(P(X))]

As the ratio of entropy to order increases, the file has either more information or more disorder. In the context of encrypting malware, the goal of the malware is to scramble the contents of user files, making them more disordered and creating entropy. Not all changes in entropy are alarming. Some processes, such as compression, increase information content and thus entropy. But substantial changes in entropy, either up or down, are more likely to be risky and thus are evaluated as inputs to the model.

In another embodiment, subsequent changes to a file are evaluated for similarity. Even if information recompressed or versions of software change, there is an underlying similarity related to the user-directed content that tends to be preserved. For example, in one embodiment a locality-based hashing algorithm is used to process the old file and the new file and to place them into a similar vector space. Even with changes, the vectors will tend to be more aligned than would be explained by the null hypothesis. In another embodiment the contents of the two files are compressed with gzip (or a similar program), which tends to increase the information content of the information, resulting in higher similarity. Either the absolute change in similarity of a file from modification to modification, or the incidence of a change in similarity above a threshold (such as 15-20%) can be provided as inputs to the model.

FIG. 5 shows another type of metadata recorded according to one embodiment—the access frequency of a file over time. The access frequency of the file can be measured from either an individual node perspective as well as from a protected organization perspective by summing all accesses from all clients. Although in one embodiment individual file accesses are provided as inputs to the model, some embodiments group accesses in order to provide higher interpretability. While this grouping can be thought of as a form of feature extraction, it is better considered to be a method of reducing the dimensionality of the data to provide higher information signals to the model.

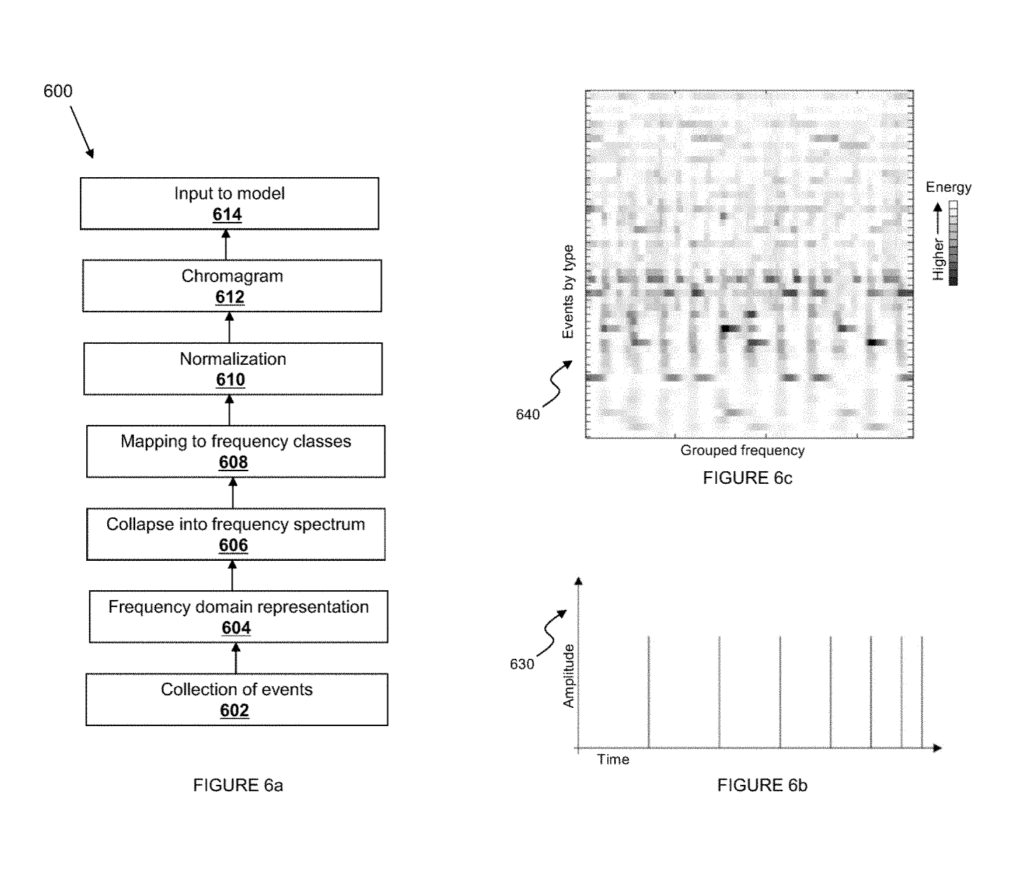

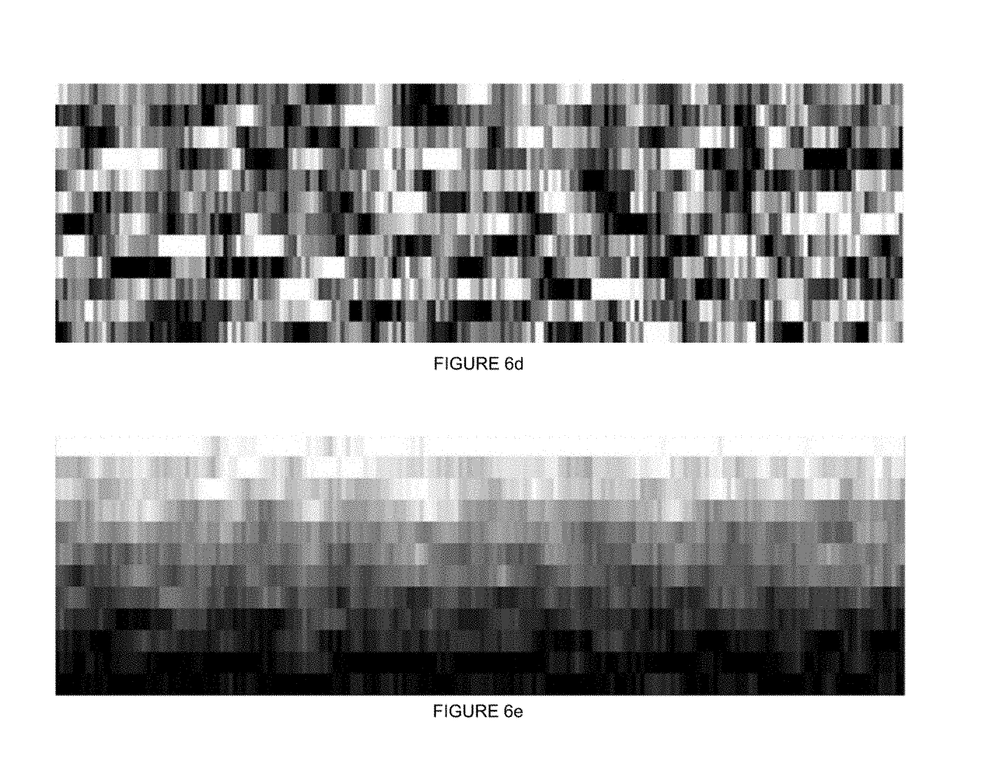

FIG. 6a shows a method of grouping data 600 according to one embodiment. At step 602, the events are collected and interpreted as a signal. In this case, the raw signal is the file access events over time as shown relative to FIG. 5, either for an individual protected node or summed across the protected system. In other embodiments, the frequency of changes to file entropy levels, the frequency of deletions, of moves, or of changes in similarity over a threshold are used. At step 604, the events are converted to a frequency domain representation. In order to convert an event into a frequency, the time between the last two matching events in this example, the last two accesses) is considered to be the relevant time frame for the grouping.

At step 606, the frequency domain representation is collapsed into a frequency spectrum. Turning briefly to FIG. 6b, graph 630 shows the result of applying a Fourier transform to the frequency data. Various recurring patterns in the in changes or accesses to a file will be shown as frequency subcomponents with amplitudes scaled to the number of events giving rise to particular event-frequency relationships. This allows the model to interpret widely-spaced events in the context of their importance to various periodic processes, and not just as noise. It is expected that some types of events will be essentially “noise,” however, so in one embodiment an amplitude filter is applied to frequency representation, dropping all events below a certain amplitude. This allows for spurious events that do not happen harmonically to be dropped.

At step 608, the events are grouped into classes, based upon their closeness to each other. In one embodiment, this is accomplished by grouping the event frequencies into a series of Gaussian functions, interpreted as fuzzy sets. Individual events can either be proportionately assigned to overlapping groups, or fully assigned to the predominant group for a particular frequency. In one embodiment, the grouping of frequencies is completely automated to avoid the introduction of human values as a filter. In another embodiment, various human-interpretable time periods are used as the basis for groupings. Exemplary time periods include one hour, one day, two days, three and one half days (i.e., half a week), a week, two weeks, a month, and a quarter. The intuition associated with automatic grouping is that natural rhythms in business processes are observable by seeing changes in user data over time, and that identifying those rhythms provides value. Alternatively, bucketing events into human-identified timeframes has the advantage of forced alignment with business decision timelines.

Turning briefly to FIG. 6c, a graphical representation of the mapping of events to frequency classes is shown at reference 640. Each increment along the y axis is an event, separated by type. Each grouping along the x axis is a range in the frequency domain. The value of the sum total of the events in a particular event x frequency domain is shown by the color of the square, with higher energy (equaling more events) occurring in that space. This visual representation of the grouping makes clear the varying periodicity in the pattern of accesses.

Turning back to process 600, at step 610 the values within a certain group are normalized. In one embodiment, the groups are characterized by the most frequent value. In another embodiment, the groups are characterized by a start or termination value (e.g. the beginning of an hour or the end of a quarter). This can be interpreted as a type of quantization of the events.

At step 612, the quantized events are turned into a chromagram. FIG. 6d shows a chromagram with the events in the original order, whereas FIG. 6c shows the same data with the events organized by total energy top to bottom. Clear classes of events can be discerned by looking at the various energy (frequency) levels associated with different types of events.

At step 614 the values from the chromagram are used as the input to the model as discussed below. While the information has been shown in graphical form in FIGS. 6b-6e, the underlying representation is a matrix of values corresponding to individual file events (or classes of file events) and their frequency representation, including a value for the energy associated with each aspect of the frequency as measured according to an input value scaled between 0.0 and 1.0. (The graphical representation shown maps these energy levels to grayscale values.)

In various embodiments, two other types of data are also subjected to frequency analysis and, represented as a matrix of data. The first is information associated with policies for backup or data retention, as managed by the policy manager 140. The policy manager has human-directed policies that indicate how frequently certain systems should be backed up and how long data should be retained. While the analysis associated with various embodiments is distinct from a pure policy-oriented “what should be” protected, the intuition remains that there has been human selection of “important” systems and data, and that there has also been a judgment of how long data remains “relevant”—i.e., valuable. A representation of what “should be” backed up is therefore coded as a frequency-file-matrix and used for evaluation by the system.

In other embodiments, a representation of the money flow associated with the organization is also represented as a feature matrix. The value of certain flows of money is represented, with the budget category (tax, employee benefits, accounts receivable by account, accounts payable by vendor, etc.) corresponding to the type of feature and the amount of the money flow corresponding to the energy associated with the flow, with values being normalized into above 0.5 values (outflow, or expenses), and below 0.5 values (inflow, or revenue). The intuition for this selection is that ultimately the monetary flows through an organization are the measure of value, and tracking those flows will show the same periodicity as the overall flow of activity, with some possible delay. Various embodiments make a number of different correlations. For example, correlating the monetary flows matrix and the file access/change matrix. This allows the actions on organization data to be correlated to monetary value (in or out). As this is a cross-correlation between two matrices with a similar time dimension, a restricted Boltzmann machine (RBM) is used to form the mapping between the input (file change) values and the output (money flow) values as a non-linear correlation. Because the time dimension is explicitly captured by running the events through a Fourier transform, the use of a recurrent neural network (RNN) or something with a memory is not needed, but an alternative implementation could also use a Long Short-Term Memory (LSTM)-based RNN and view the information as a time series with online learning.

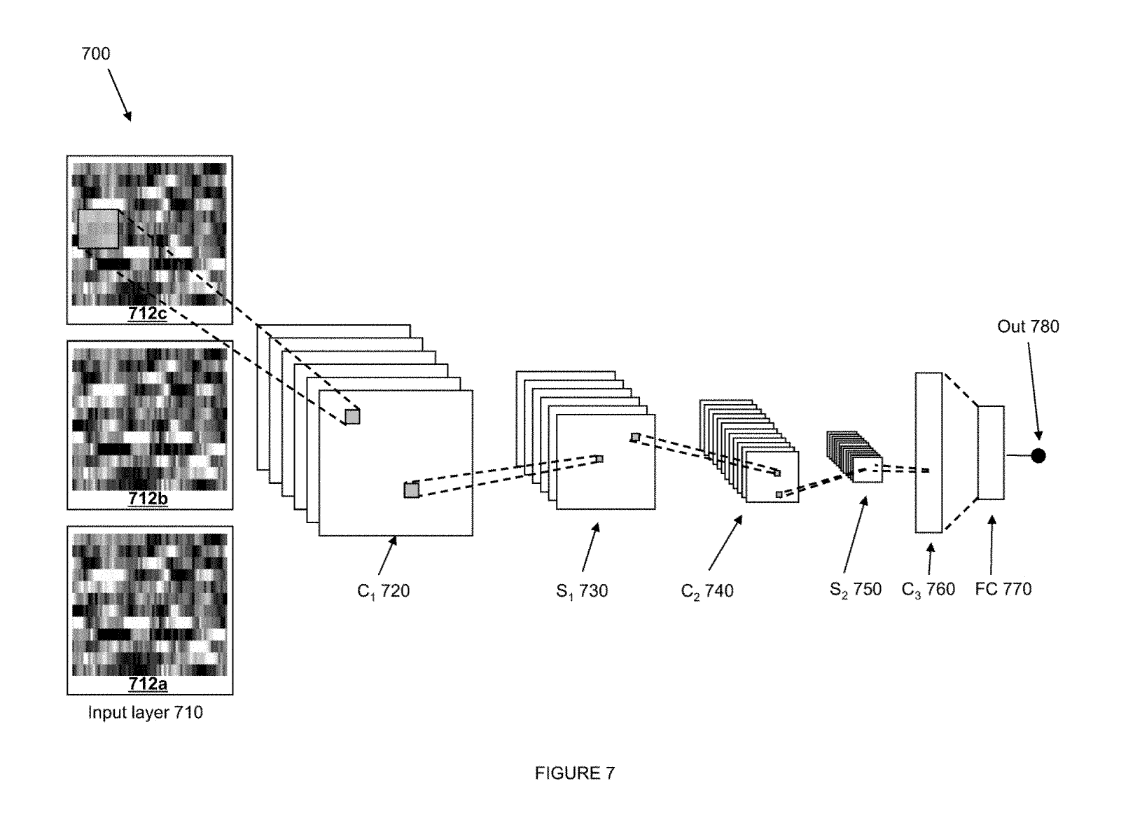

As discussed, the cadence and value of various business processes is evaluated by correlating the financial flows with the underlying system information. FIG. 7 shows a system for correlating observed system information with business continuity value according to one embodiment. The system 700 is a multilayer convolutional neural network (CNN) consisting of seven layers. In one embodiment, input layer 710 takes a set of input matrices that are concatenated together. The concatenated matrices are 712a, the file events matrix, 712b the policy events matrix, and 712c the monetary flows matrix. If necessary, the matrices are grouped or “stretched” to make sure that they have a consistent dimension so that the input dimensions are consistent. In a separate embodiment, some aspects of the various matrices can be encoded into separate channels. For example, the actual file events matrix 712a is encoded into the “R” element of an RGB pixel, the policy events matrix is encoded into the “G” element of an RGB pixel, and the result of a correlation between the file events and the monetary events matrix (corresponding to the value, positive or negative, imputed to each file action) are encoded into the “B” element of an RGB pixel. The time dimension is identical for all three matrices so that they stay aligned.

Turning to layers C₁ 720, S₁ 730, C₂ 740 S₂ 750, and C₃ 760, each C layer is a fully convolutional layer and each S layer is a subsampling layer. In one embodiment, each of the convolutional layers 720, 740, and 760 have six hidden layers with a 5×5 convolution, and each of the subsampling layers 730 and 750 divide the input size by one half, with activation function:

yᵢ=φ(vⱼ)=A tanh(Svⱼ) (Eq. 1)

The FC layer 770 is a fully-connected RBM with one input unit used for each input pixel after layer 760, and 2n hidden layers. The output 780 corresponds to an estimated value of the current expected monetary flow (in or out) given the observed data.

Those of skill in the art will note that CNN 700 is a variation the LeNet CNN architecture, but the observed function is a mapping of matrix data to a scalar value. Other CNN architectures can also be substituted. This allows a number of different evolving neural network architectures to be used. The method of training these CNN architectures, including learning rate, dropout, and number of epochs varies according to the architecture used. In one implementation, a backpropagation method is used to train the CNN to have the proper weights when presented with a ground truth output from a set of inputs. In this implementation, the output value is the change in value associated with a particular monetary flow, such as revenue, cost, liabilities, or total book value over the same time period (and usually some associated period after) the period where observational data is used to train the CNN. Each successive observation of the change in value is used as a separate training opportunity, and by minimizing the error over time the entire network can be simultaneously trained and used.

Various unique advantages are evident to those of skill in the art based upon one or more embodiments. In one embodiment, the interpretation of file change data as a set of frequencies of different types of changes and the correlation of that information to explicit money flows allows the real-time valuation of different changes to an organization.

In one embodiment, the value of all policy-based file events is added to all non-policy based events and evaluated for the expected value of the underlying flows. A policy that tends to preserve important files will have a higher expected value, thus providing a feedback target for evaluating different policies.

In one embodiment, the divergence between ideal policies (as measured by an overlay) and existing policies is interpreted as additional risk to the money flows of the organization, and, the difference in the expected values of the money flows is the risk value that can be used for insuring against adverse events.

In one embodiment, the changing value of the expected value of the sum of all user data changes in an organization is usable as a real-time risk monitor. New changes that are not protective of key files and processes will have either a less-positive or negative value, even if they have not been seen before. Thus, changes in expected value (and, associated business risk) will be immediately apparent, allowing the dynamic pricing of risk and real-time corrective measures.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A system for detecting and recognizing significant file access patterns, the system comprising:
a plurality of information processing systems under common business control, each information processing system including a processor and a memory, an operating system executing on the processor, wherein the information processing system is coupled to at least one storage, the at least one storage including a first plurality of files organized in a first file system, and wherein the operating system moderates access to the first plurality of files by system processes executing on the processor;
a plurality of event monitors associated with the plurality of information processing systems, where each information processing system is associated with an event monitor, and wherein each event monitor captures file access and change events from the coupled storages from their respective associated information processing systems, wherein the file access and change events are keyed to their time of occurrence and are converted into a plurality of file activity event streams;
a first time series accumulator receiving the plurality of file activity event streams and correlating them according to their time of occurrence;
a financial flow event reporter under common business control with the plurality of information processing systems, the financial flow event reporter capturing the magnitude and direction of changes to and transfers between a set of budget categories as a set of financial events, wherein the financial events are keyed to their time of occurrence; and further capturing the magnitude and change in the net value of the financial flows;
a neural processor, the neural processor including:
a frequency domain transformer operable to take a set of events and represent them as an event feature matrix, each correlated event type being represented by a first dimension in the matrix and the occurrence information being represented by a second dimension in the matrix;
a matrix correlator operable to align a set of feature matrices according to one or more shared dimensions;
a neural network trained with a multidimensional mapping function associating a first set of input feature matrices output from the matrix correlator with an output feature matrix;
wherein the set of input feature matrices includes a file event feature matrix and a financial event feature matrix, and wherein the shared correlating dimension is a time dimension; and
wherein the output feature matrix represents change in the net value of one or more financial flows over a time linearly related to the shared correlating time dimension.

2. The system of claim 1, wherein the frequency domain transformer applies a fourier transformation to the event stream.

3. The system of claim 1, wherein at lesat one feature matrix is implemented as a chromagram.

4. The system of claim 1, further comprising a policy event projector, wherein a series of planned file access and change events keyed to their time of occurrence are converted into a plurality of planned file activity event streams, and wherein the set of input feature matrices further includes a matrix created by applying the frequency domain transformer to the planned file activity event stream.

5. The system of claim 1, wherein the neural network is multi-level convolutional neural network.

6. The system of claim 5, wherein the convolutional neural network has alternating fully convolutional and subsampling layers.

7. The system of claim 6, wherein the neural network has an output layer comprising a restricted Boltzmann machine.

8. A system for correlating significant institutional patterns with an expected value result, the system comprising:
a neural correlator converting a set of time-correlated input streams to an output matrix representing a time-varying value, the neural correlator including:
a converter applying a frequency decomposition to a set of time-varying signals, the time-varying signals representing human business activities;
a classifier grouping events into time-oriented classes;
a quantizer converting measurements of the frequency of similarly classified events into scalar values;
a matrix generator from a set of converted, classified, and quantized values;
a correlator of multiple matrices into a single multidimensional matrix along a shared time scale;
a neural network including a set of alternating convolutional and subsampling layers, wherein each subsampling layer has reduced dimensionality, followed by a restricted Boltzmann machine;
wherein the output matrix is read from the output of the restricted Boltzmann machine.

9. The system of claim 8 wherein the matrix generator creates chromagrams.

10. The system of claim 8 further comprising an amplitude filter removing events of insufficient amplitude from the time-varying signals.

11. The system of claim 8 wherein the output matrix is a single-element matrix.

12. The system of claim 8 wherein the output matrix is a 1×N matrix of expected dollar values along a time scale linearly related to the time scale of the time-correlated input streams.

13. A method of calculating the expected future value of a set of activities, the method comprising:
a) collecting a first set of business-correlated events over a first defined time period;
b) interpreting the first set of business-correlated events as a set of periodic signals;
c) converting the periodic signals to the frequency domain;
d) transforming the frequency domain representation into a spectrum representation;
e) applying a filter function to remove low-amplitude elements of the spectrum representation;
f) grouping the events into classes based upon their closeness in time and/or frequency;
g) quantizing the groups of events;
h) normalizing the quantized values;
i) representing the normalized groups of values as a chromagram;
j) inputting the the chromagram to a convolutional neural network;
k) reading the output from the convolutional neural network; and
l) interpreting the output of the convolutional neural network as an expected value of the set of business-correlated events put on the input.

14. The method of claim 13, further comprising the steps of:
prior to the first defined time period, collecting a second set of business-correlated events over a second time period, the second time period occurring before the first time period;
collecting a set of output values during the second time period, wherein the output values correspond to the positive or negative change in economic value associated with the business-correlated events interpreted as a whole;
applying steps a-l to the second set of business-correlated events;
applying a learning algorithm to identify a set of weights associated with hidden layer activation functions in the CNN.

15. The method of claim 14, further comprising the step of applying a learning algorithm to each successive observation during the first defined time period.

16. The method of claim 14, wherein the learning algorithm uses a backpropagation technique.

17. The method of claim 14, further comprising the steps of:
applying steps a-i to a set of first set of business-correlated events corresponding to file access and change patterns;
applying steps a-i to a second set of business-correlated events corresponding to financial budget data;
creating a correlated matrix from the results of the application of steps a-i to the first and second sets of business-correlated events according to a common time dimension; and
using the correlated matrix as the input to step j.

18. The method of claim 17, further comprising the steps of:
applying steps a-i to a set of third set of business-correlated events corresponding to proposed or actual file access and change patterns resulting from policy actions; and
creating the correlating matrix also using the third matrix resulting from the application of steps a-i to the third set of business-correlated events.

19. The method of claim 13, wherein the application of the convolutional neural network further comprising the steps of:
applying an alternating set of hidden fully convolutional and subsampling layers;
using the output of the final hidden layer to a restricted Boltzmann machine; and
receiving the output of the restricted Boltzmann machine.

20. The method of claim 19, wherein each subsampling layer is reduced in size.
